(19) United States
(12) Patent Application Publication
(10) Pub. No.: US 2021/0033496 A1
(43) Pub. Date: Feb. 4, 2021

(54) EXCITATION DEVICE

(71) Applicant: Honda Motor Co.,Ltd., Tokyo (JP)

(72) Inventor: Susumu AKUTSU, Tochigi (JP)

(73) Assignee: Honda Motor Co.,Ltd., Tokyo (JP)

(21) Appl. No.: 16/944,172

(22) Filed: Jul. 31, 2020

(30) Foreign Application Priority Data
Jul. 31, 2019 (JP) 2019-140633

(51) Int. Cl. G01M 17/04; G01M 17/007

(52) U.S. Cl. CPC G01M 17/045; G01M 17/0078

(57) ABSTRACT

The disclosure provides an excitation device capable of reproducing an excited state during traveling of a vehicle, reducing the cost, and realizing vehicle maintenance during excitation. An excitation device (1) holds a wheel (W) of a vehicle (V) between a first roller (17) and a second roller (16), and drives the second roller (16) in a front-rear direction with a hydraulic actuator (12) to excite the wheel (W). A ground base (18) is arranged between the first roller (17) and the second roller (16), and an interval between an upper end of the ground base (18) and the upper ends of front and rear mounting plates (5) and (6) which are the highest is set to a value smaller than a minimum ground clearance of the vehicle (V).

### CROSS-REFERENCE TO RELATED APPLICATION

This application claims the priority benefits of Japanese application no. 2019-140633, filed on Jul. 31, 2019. The entirety of the above-mentioned patent application is hereby incorporated by reference herein and made a part of this specification.

### BACKGROUND

### Technical Field

The disclosure relates to an excitation device that excites each wheel of a vehicle to be excited.

### Description of Related Art

A device described in Patent Document 1 is known as an excitation device. The excitation device is applied to a vehicle inspection device that performs a durability test for a four-wheel vehicle, and the excitation device includes a total of four exciters for left and right front wheels and left and right rear wheels. Each exciter is provided for exciting the corresponding wheel, and includes a vertical actuator that generates vibration in a vertical direction, a mounting table that is excited by the vertical actuator, a front-rear actuator that generates vibration in a front-rear direction, and a vibration plate driven by the front-rear actuator.

In the vehicle inspection device, when the wheels are mounted on the mounting tables, the vibration plate of the front wheel exciter comes into contact with the front wheel from the front obliquely in an inclined position, and the vibration plate of the rear wheel exciter comes into contact with the rear wheel from the rear obliquely in an inclined position. Then, vibrations from the four vertical actuators and the four front-rear actuators are input to the four wheels, respectively.

### RELATED ART

### Patent Document

[Patent Document 1] Japanese Laid-Open No. 2007-147394

Generally, when a vehicle is actually traveling, both the front wheels and the rear wheels receive a force from the traveling direction so the wheels are excited from the same direction. In contrast thereto, according to the excitation device of Patent Document 1, the front wheels are excited from the front by the vibration plates of the front wheel exciters but the rear wheels are excited from the rear by the vibration plates of the rear wheel exciters, resulting in the problem that the excited state during traveling of the vehicle cannot be reproduced appropriately. In addition, since two actuators are required for each wheel, the cost increases accordingly.

Furthermore, if the wheels come off from the vibration plates for some reason during excitation, the vehicle may fall down from the mounting tables, and the vehicle may be damaged.

In view of the above, the disclosure provides an excitation device capable of reproducing the excited state during traveling of the vehicle, reducing the cost, and realizing vehicle maintenance during excitation.

### SUMMARY

According to an embodiment of the disclosure, an excitation device 1 includes: a plurality of components respectively exciting a plurality of wheels W of a vehicle V to be excited, and located below a minimum ground clearance portion of the vehicle V during excitation. The plurality of components include: a first contact part (first roller 17) arranged to come into contact with each of the wheels W from one direction in a front-rear direction of the vehicle V and restrict movement of each of the wheels W to the one direction in the front-rear direction of the vehicle V; a second contact part (second roller 16) arranged to be movable in the front-rear direction of the vehicle V and to come into contact with each of the wheels W from an other direction in the front-rear direction of the vehicle V and hold a lower side of each of the wheels W between the first contact part and the second contact part; an actuator (hydraulic actuator 12) driving the second contact part in the front-rear direction of the vehicle V and exciting each of the wheels W via the second contact part; and a grounding part (ground base 18) arranged between the first contact part and the second contact part and grounding each of the wheels W. An interval between an upper end of the grounding part (ground base 18) and an upper end of a highest component (front and rear mounting plates 5 and 6) among the plurality of components other than the grounding part is set to a value smaller than a minimum ground clearance of the vehicle V.

### BRIEF DESCRIPTION OF THE DRAWINGS

FIG. 1 is a perspective view showing an appearance of an excitation device according to an embodiment of the disclosure.

FIG. 2 is a plan view showing a state where a tread corresponding interval and a wheelbase corresponding interval between four exciters are set to maximum values.

FIG. 3 is a plan view showing a state where the tread corresponding interval and a wheelbase corresponding interval between the four exciters are set to minimum values.

FIG. 4 is a perspective view showing a configuration of a hydraulic clamp device.

FIG. 5 is a perspective view showing a configuration of a front mounting plate and an exciter.

FIG. 6 is a perspective view showing a configuration of the exciter.

FIG. 7 is a plan view showing a state where a second roller of the exciter is at an excitation position.

FIG. 8 is a side view showing a cross section taken along the line C-C of FIG. 7.

FIG. 9 is a plan view showing a state where the second roller of the exciter is at a push-out position.

FIG. 10 is a side view showing a cross section taken along the line D-D of FIG. 9.

FIG. 11 is a view showing a state where a vehicle is mounted so as to be excited in the excitation device.

FIG. 12 is an explanatory view showing a pressing force acting on a wheel during excitation and force components thereof.

FIG. 13 is a view showing a state immediately before the vehicle gets out of the exciters.

### DESCRIPTION OF THE EMBODIMENTS

According to the excitation device, the first contact part comes into contact with each wheel from one direction in the front-rear direction of the vehicle, by which the movement of each wheel to one direction in the front-rear direction of the vehicle is restricted. In addition, the second contact part arranged to be movable in the front-rear direction of the vehicle comes into contact with each wheel from the other direction in the front-rear direction of the vehicle, by which the lower side of each wheel is held between the first contact part and the second contact part. Then, the second contact part is driven by the actuator in the front-rear direction of the vehicle so that each wheel is excited via the second contact part. Since the wheels are excited from the same direction, unlike the excitation device of Patent Document 1, the excitation device of the present embodiment can appropriately reproduce the excited state during traveling of the vehicle (note that the term “wheel” in this specification is not limited to a vehicle wheel and refers to a configuration including both a wheel and a tire in the case of a wheel provided with a tire, and in that case, the tire includes not only a pneumatic tire but also an airless tire).

Further, since the second contact part is driven in the front-rear direction of the vehicle by the actuator in the state where the lower side of each wheel is held between the first contact part and the second contact part, the vibration is input obliquely upward to the contact point between each wheel and the second contact part. Thus, the vibrations of the force components act on each wheel in the front-rear direction and the vertical direction, and therefore the excitation device for exciting each wheel in the front-rear direction and the vertical direction can be configured with one actuator. As a result, the manufacturing cost can be reduced as compared with the excitation device of Patent Document 1 which requires two actuators.

Furthermore, in the plurality of components located below the minimum ground clearance portion of the vehicle during excitation, the grounding part for grounding each wheel is arranged between the first contact part and the second contact part, and the interval between the upper end of the grounding part and the upper end of the highest component among the plurality of components other than the grounding part is set to a value smaller than the minimum ground clearance of the vehicle. Thus, even if the wheel held between the first contact part and the second contact part falls downward for some reason and causes the wheel to touch the grounding part, a gap remains between the minimum ground clearance portion of the vehicle and the higher one of the upper end of the first contact part and the upper end of the second contact part, and they can be prevented from contacting each other. Thus, damage to the vehicle can be avoided, and vehicle maintenance during excitation can be realized.

In the excitation device 1 according to an embodiment of the disclosure, the plurality of components further include a guiding part (front and rear mounting plates 5 and 6) as the highest component. The guiding part (front and rear mounting plates 5 and 6) has an opening 5g, 6g having a size larger than a size of a tread of each of the wheels W in the front-rear direction and a left-right direction and guides each of the wheels W between the first contact part (first roller 17) and the second contact part (second roller 16), and the first contact part and the second contact part are arranged below the opening of the guiding part, and an interval between the upper end of the grounding part (ground base 18) and the upper end of the guiding part (front and rear mounting plates 5 and 6) is set to a value smaller than the minimum ground clearance of the vehicle V.

According to the excitation device, the plurality of components further include the guiding part as the highest component, and the guiding part is for guiding each wheel between the first contact part and the second contact part. The guiding part has an opening having a size that is larger than the size of the tread of each wheel in the front-rear direction and the left-right direction, and the first contact part and the second contact part are arranged below the opening of the guiding part. Thus, even if the wheel held between the first contact part and the second contact part falls downward for some reason and causes the wheel to touch the grounding part, a gap remains between the minimum ground clearance portion of the vehicle and the upper end of the guiding part, and they can be prevented from contacting each other. Thus, when the guiding part is present, vehicle maintenance during excitation can be realized.

In the excitation device 1 according to an embodiment of the disclosure, the first contact part and the second contact part respectively include a first roller 17 and a second roller 16 that are rotatable around an axis line extending in a vehicle width direction of the vehicle V, and the second roller 16 is configured to be rotatable only in a rotation direction when the second roller 16 moves away from each of the wheels W in a state where the second roller 16 is in contact with each of the wheels W.

According to the excitation device, the second roller is configured to be rotatable only in the rotation direction when the second roller moves away from each wheel in the state where the second roller is in contact with each wheel. Thus, at the time of exciting each wheel, the second roller is in the rotation stopped state when approaching each wheel so as to transmit the vibration to each wheel. On the other hand, the second roller rotates in the direction opposite to each wheel when moving away from each wheel so as not to transmit the vibration, and each wheel does not receive extra force from the second roller.

In this case, during actual traveling, each wheel receives vibration and force from the traveling direction, but hardly receives vibration and force from the direction opposite to the traveling direction. Accordingly, with the simple structure of two rollers, vibration can be input to each wheel from one direction as in actual traveling, and the excited state during traveling of the vehicle can be appropriately reproduced.

In the excitation device 1 according to an embodiment of the disclosure, the second roller 16 is driven by the actuator (hydraulic actuator 12) at least between a first position (the position in FIG. 8) where each of the wheels is held between the first roller 17 and the second roller 16, and a second position (the position in FIG. 10) closer to the side of the first roller 17 than the first position, and the plurality of components further include a stopper (passage base 19) that comes into contact with the second roller 16 when the second roller 16 is at the second position, and stops rotation of the second roller 16.

According to the excitation device, the second roller is driven by the actuator at least between the first position where each wheel is held between the first roller and the second roller, and a second position closer to the first roller side than the first position. Then, when the second roller is at the second position, the stopper comes into contact with the second roller so that the rotation of the second roller is stopped. Thus, after the excitation is completed, by moving the second roller to the second position, each wheel can easily get out of the space between the two rollers while riding over the second roller in the rotation stopped state, which is more convenient.

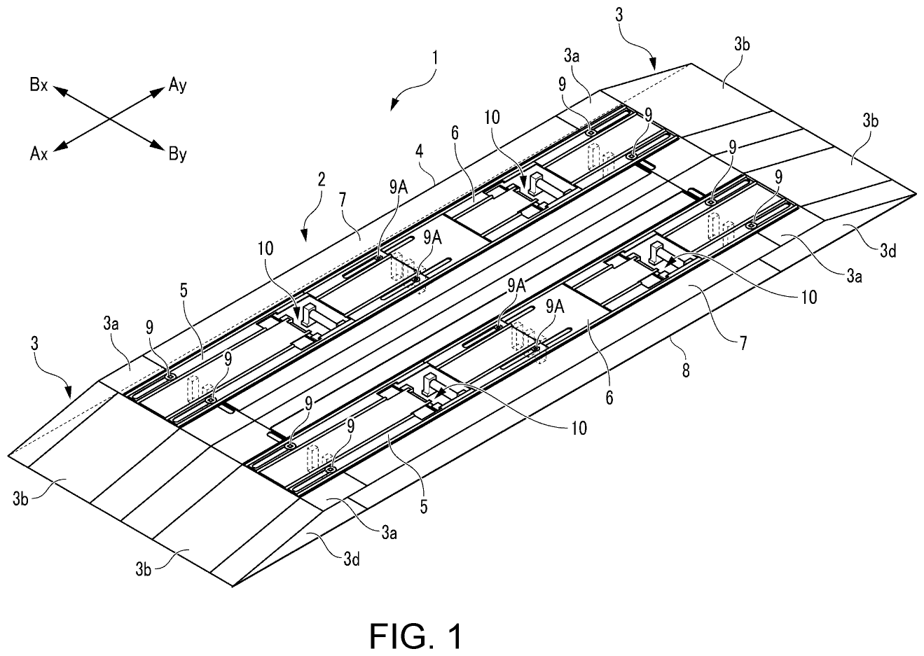

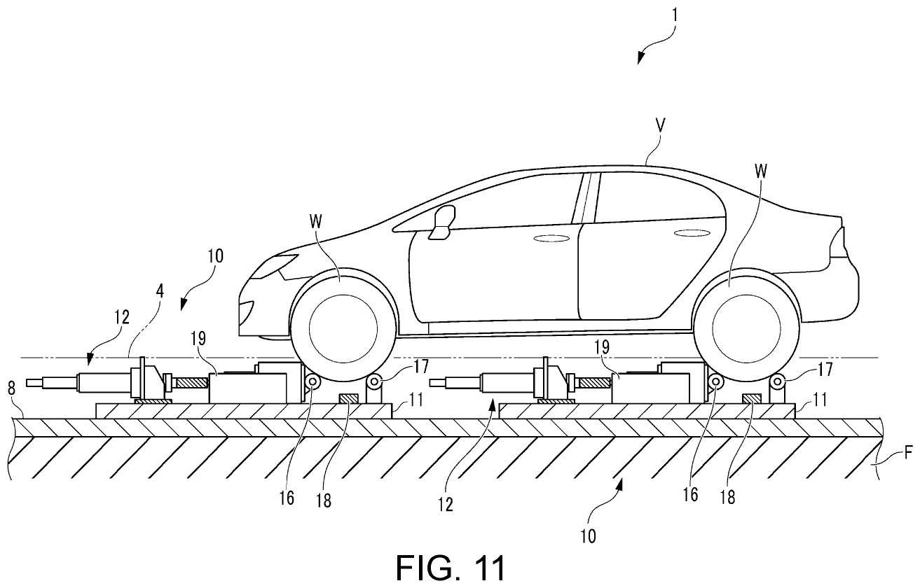

Hereinafter, an excitation device according to an embodiment of the disclosure will be described with reference to the drawings. The excitation device 1 shown in FIG. 1 of the present embodiment is applied to a vehicle inspection device for inspecting a vehicle V (see FIG. 11), and the excitation device 1 is provided with four exciters 10.

In the excitation device 1, as described later, four wheels W (see FIG. 8 and FIG. 11) of the vehicle V to be inspected are excited by the four exciters 10 respectively, thereby inspecting the vehicle V for abnormal noise or the like. In the following description, for convenience, the Ax side of the arrow Ax-Ay in FIG. 1 is called “front”, the Ay side is called “rear”, the Bx side of the arrow Bx-By is called “left”, the By side is called “right”, the upper side is called “top”, and the lower side is called “bottom”.

The excitation device 1 includes a mounting table 2 for mounting the vehicle V at the time of inspection. The mounting table 2 is installed on a floor surface (not shown), and is located below a minimum ground clearance portion of the vehicle V at the time of inspection. Since the left half and the right half of the mounting table 2 are configured to be plane-symmetric, as shown in FIG. 1 to FIG. 3, the left half is described as an example hereinafter.

The left half of the mounting table 2 includes a mounting part 4 that has a rectangular shape in the plan view and extends in a front-rear direction, and front and rear slope parts 3 provided before and after the mounting part 4. The front slope part 3 defines a flat part 3a and an inclined surface 3b. A surface of the flat part 3a is continuous with the front end of the mounting part 4. The inclined surface 3b is continuous with the flat part 3a and extends obliquely downward to the front.

A long hole 3c is formed in the flat part 3a. The long hole 3c has a predetermined width in the front-rear direction and extends at a predetermined length in a left-right direction with a predetermined interval between the long hole 3c and an edge of an opening 7a (will be described later) of a top plate 7, and two ends of the long hole 3c are formed in a semicircular shape in the plan view.

A plurality of supports (not shown) are provided inside the front slope part 3. The upper ends of these supports are fixed to the flat part 3a and the inclined surface 3b, and the lower ends thereof are fixed to the bottom surface part 3d of the slope part 3. Thus, a force acting on the front slope part 3 from above is supported by these supports.

In addition, the rear slope part 3 defines a flat part 3a and an inclined surface 3b. A surface of the flat part 3a is continuous with the rear end of the mounting part 4. The inclined surface 3b is continuous with the flat part 3a and extends obliquely downward to the rear. A long hole 3c is also formed in the flat part 3a, and the long hole 3c is configured similarly to the long hole 3c of the front slope part 3. A plurality of supports (not shown) similar to those of the front slope part 3 are provided inside the rear slope part 3.

Further, the rear slope part 3 defines an inclined surface that has a surface continuous with the rear end of the mounting part 4 and extends obliquely downward to the rear. The vehicle V moves from the floor surface onto the mounting part 4 via the rear slope part 3 when the inspection is started, and moves from the mounting part 4 to the floor surface via the front slope part 3 after the inspection is completed.

In addition, the mounting part 4 includes front and rear mounting plates 5 and 6, the top plate 7, a base plate 8, etc. in order from top to bottom. In the present embodiment, the front and rear mounting plates 5 and 6 correspond to a component and a guiding part.

The base plate 8 has a flat plate shape that extends in the front-rear direction in a rectangular shape in the plan view. The front and rear ends of the base plate 8 are integrally fixed to the front and rear slope parts 3. The base plate 8 is mounted on the floor surface and is firmly fixed to a floor F (see FIG. 8) via a fixture (not shown; for example, an anchor bolt).

The top plate 7 has a rectangular shape in the plan view and extends in the front-rear direction, and the top plate 7 is arranged in parallel to the base plate 8. The top plate 7 is provided with the opening 7a. The opening 7a is arranged at the center of the top plate 7 and is formed in a rectangular shape that is horizontally long in the plan view, and the opening 7a penetrates the top plate 7 in a vertical direction.

The front mounting plate 5 has a rectangular shape that is horizontally long in the plan view and extends in the front-rear direction, and four ribs 5a are provided on a surface of the front mounting plate 5. The four ribs 5a extend in the front-rear direction, and the two ribs 5a on the inner side define a traveling path and have a function of guiding the wheels W of the vehicle V. Thus, at the time of inspection, the wheels W are guided by the front mounting plate 5 as the vehicle V rides on the mounting table 2 and moves to an inspection position (see FIG. 11).

A front end of the front mounting plate 5 is mounted on the flat part 3a of the front slope part 3, and a pair of long holes 5b are formed between the two ribs 5a at the left and right ends. The long holes 5b extend in the front-rear direction in parallel to each other. The front end of the front mounting plate 5 is fixed to the front slope part 3 via a hydraulic clamp device 9 at the edges of the long holes 5b.

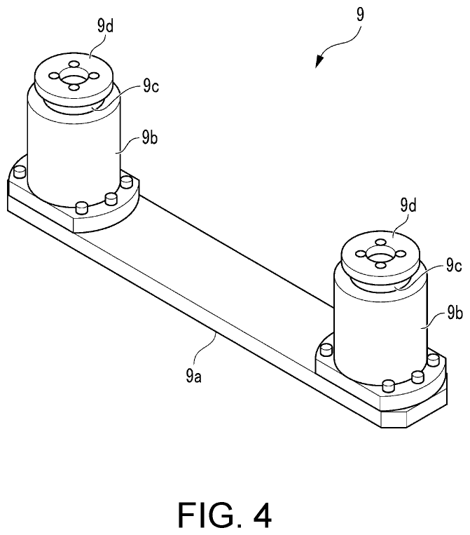

As shown in FIG. 4, the hydraulic clamp device 9 includes a connecting plate 9a and two hydraulic cylinders 9b, and the hydraulic cylinders 9b are screwed to the upper surface of the connecting plate 9a.

Each hydraulic cylinder 9b is provided with a piston rod 9c, and a flange 9d is integrally provided at the upper end of the piston rod 9c. In the hydraulic clamp device 9, the hydraulic pressure supplied from a hydraulic circuit (not shown; will be described later) to the hydraulic cylinder 9b is controlled by a control device (not shown), by which the piston rod 9c expands/contracts from the hydraulic cylinder 9b in the vertical direction.

In the case of the hydraulic clamp device 9, the front mounting plate 5 and the flat part 3a of the front slope part 3 are held between the lower surface of the flange 9d and the upper end surface of the hydraulic cylinder 9b in a state where each piston rod 9c is fitted into the long hole 5b of the front mounting plate 5 and the above-described long hole 3c of the front slope part 3. Thus, the front mounting plate 5 is fixed to the front slope part 3.

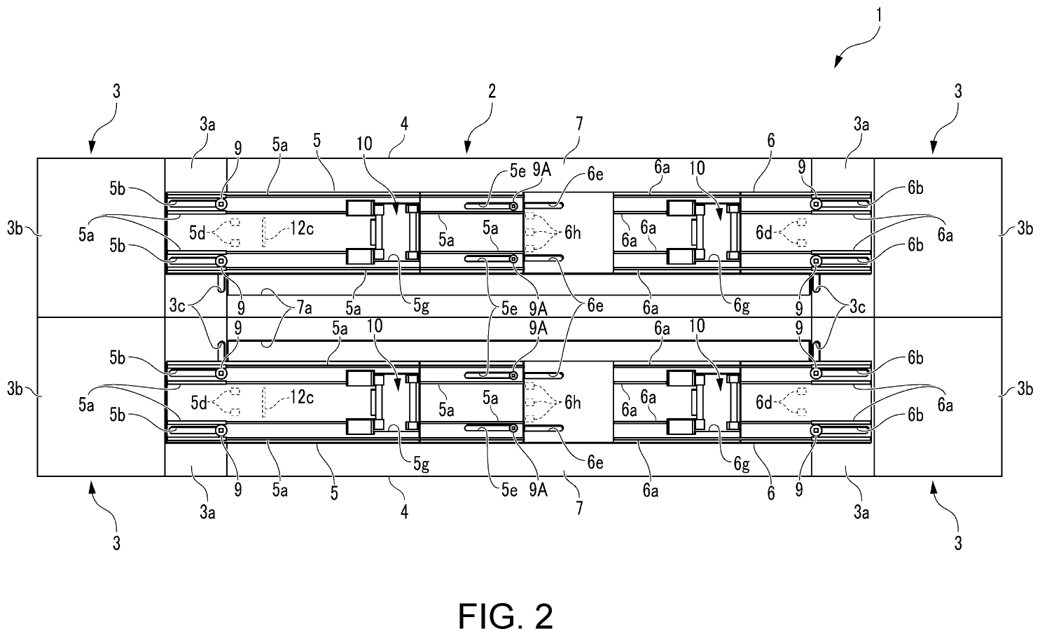

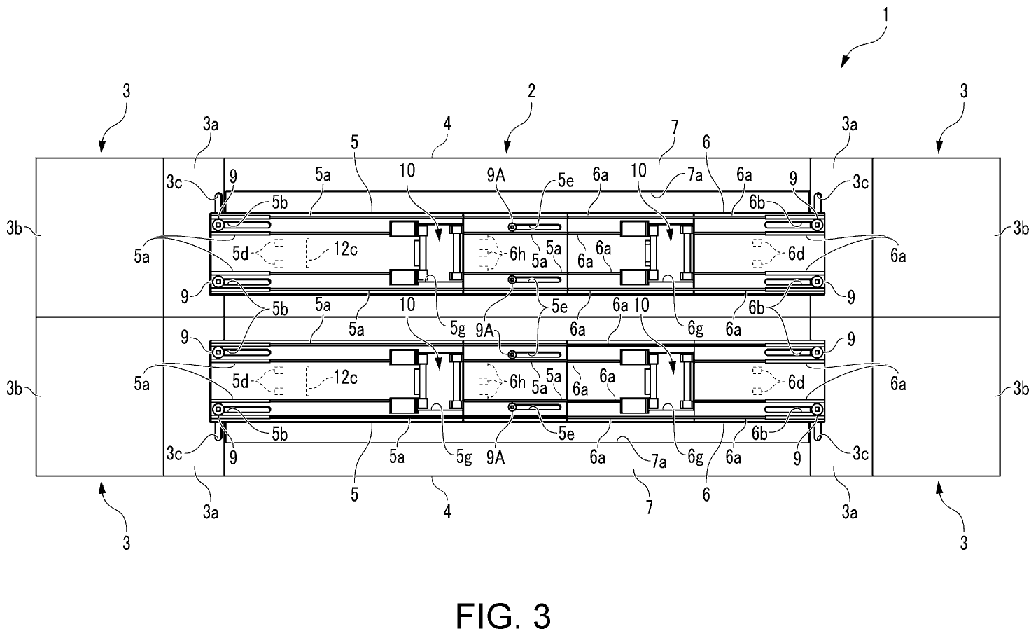

Further, in this state, the piston rod 9c extends relatively upward from the hydraulic cylinder 9b to release the fixing of the front mounting plate 5 to the front slope part 3. In such a state where the fixing of the front mounting plate 5 to the front slope part 3 is released, the piston rod 9c can move in the left-right direction while being guided by the long hole 3c of the front slope part 3 so the front mounting plate 5 can move in the left-right direction by the length of the long hole 3c. Specifically, the front mounting plate 5 is configured to be movable in the left-right direction between a maximum width position shown in FIG. 2 and a minimum width position shown in FIG. 3.

In addition, the rear end of the front mounting plate 5 is mounted on the upper surface of the front end of the rear mounting plate 6, and a pair of long holes 5e are formed at the left and right ends. Each of the long holes 5e has the same length in the front-rear direction as each of the long holes 5b, and the center line extending in the front-rear direction is arranged on the same straight line as the center line of each long hole 5b.

A piston rod (not shown) of a hydraulic clamp device 9A is fitted into each long hole 5e, and the piston rod is also fitted into a long hole 6e of the rear mounting plate 6 (will be described later). The hydraulic clamp device 9A is configured similarly to the above-described hydraulic clamp device 9 except that the hydraulic clamp device 9A is slightly smaller in size, and therefore a description thereof will be omitted.

With the above configuration, in a state where the fixing of the hydraulic clamp devices 9 and 9A is released, an edge of the long hole 5b of the front mounting plate 5 can move along the piston rod 9c of the hydraulic clamp device 9, and an edge of the long hole 5e of the front mounting plate 5 can move along the piston rod of the hydraulic clamp device 9A.

Thus, the front mounting plate 5 can move in the front-rear direction relative to the front slope part 3 by the lengths of the long holes 5b and 5e in the front-rear direction. Specifically, the front mounting plate 5 is configured to be movable in the front-rear direction between a maximum length position shown in FIG. 2 and a minimum length position shown in FIG. 3.

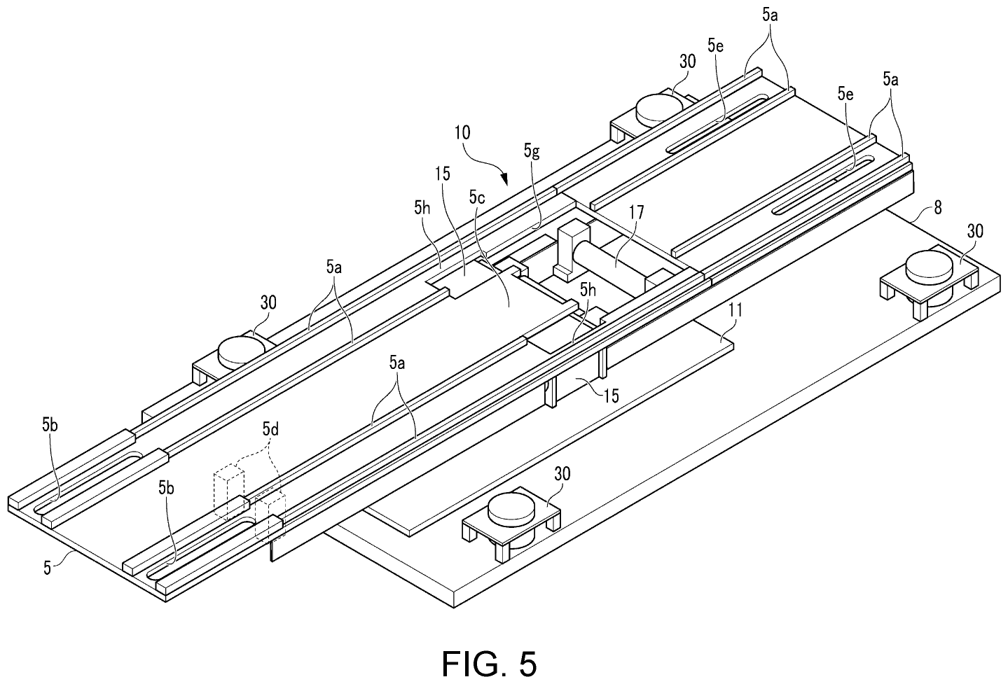

Furthermore, a pair of supports 5d are provided on the back surface of the front end of the front mounting plate 5 (see FIG. 5). The supports 5d extend downward from a portion slightly behind the rear end of the long hole 5b in a state of being spaced from each other in the left-right direction.

When the front mounting plate 5 is fixed to the front slope part 3, the lower end of each support 5d is in contact with the upper surface of the base plate 8. Thus, a force acting on the front mounting plate 5 from above is supported by the supports 5d.

The rear end of the front mounting plate 5 is fixed to the rear mounting plate 6 while being pressed against the front end of the rear mounting plate 6 by the hydraulic clamp device 9A.

An opening 5g is provided behind the center of the front mounting plate 5. The opening 5g is formed in a rectangular shape in the plan view and penetrates the front mounting plate 5 in the vertical direction. The exciter 10 is arranged below the opening 5g, and details of the exciter 10 will be described later.

The opening 5g is provided for the lower side of the wheel W of the vehicle V to be held by a first roller 17 and a second roller 16 of the exciter 10 via the opening 5g when the vehicle V is inspected, as will be described later.

Therefore, a width of the opening 5g in the left-right direction is set to be much larger than a width of an installation surface of the wheel W, and a length of the opening 5g in the front-rear direction is set to be much larger than a length of the installation surface of the wheel W in the front-rear direction. Thus, when the lower side of the wheel W is excited in a state of being held by the first roller 17 and the second roller 16, the wheel W does not interfere with an edge of the opening 5g.

Next, the rear mounting plate 6 will be described. The rear mounting plate 6 has a rectangular shape that is horizontally long in the plan view and extends in the front-rear direction, and four ribs 6a are provided on a surface of the rear mounting plate 6. Each of the four ribs 6a has the same function as each of the four ribs 5a described above, and the center line extending in the front-rear direction is arranged on the same straight line as the center line of each of the four ribs 5a described above.

Similar to the ribs 5a, the ribs 6a also define a traveling path and have a function of guiding the wheels W of the vehicle V. Thus, at the time of inspection, the wheels W are guided by the rear mounting plate 6 as the vehicle V rides on the mounting table 2 and moves to the inspection position. In the mounting table 2, the upper ends of the ribs 5a and 6a are set at the same height and are the highest portions of the mounting table 2.

The upper surface of the rear end of the rear mounting plate 6 is arranged at the same height as the upper surface of the front end of the front mounting plate 5 described above, and the rear end of the rear mounting plate 6 is configured to be plane-symmetric with the front end of the front mounting plate 5. That is, the rear end of the rear mounting plate 6 is mounted on the flat part 3a of the rear slope part 3, and a pair of long holes 6b are formed between the two ribs 6a at the left and right ends.

The piston rod 9c of the hydraulic clamp device 9 is fitted into each long hole 6b, and the piston rod 9c is also fitted into the long hole 3c of the rear slope part 3.

The rear end of the front mounting plate 5 is mounted on the upper surface of the front end of the rear mounting plate 6, and a pair of long holes 6e are formed at the left and right ends. Each of the long holes 6e has the same length in the front-rear direction as each of the long holes 6b, and is arranged concentrically with each long hole 6b in the front-rear direction. As described above, the piston rod of the hydraulic clamp device 9A is fitted into each long hole 6e.

With the above configuration, in a state where the fixing of the hydraulic clamp devices 9 and 9A is released, an edge of the long hole 6b of the rear mounting plate 6 can move along the piston rod 9c of the hydraulic clamp device 9, and an edge of the long hole 6e of the rear mounting plate 6 can move along the piston rod of the hydraulic clamp device 9A.

Thus, the rear mounting plate 6 can move in the front-rear direction relative to the rear slope part 3 by the lengths of the long holes 6b and 6e in the front-rear direction. Specifically, the rear mounting plate 6 is configured to be movable in the front-rear direction between a maximum length position shown in FIG. 2 and a minimum length position shown in FIG. 3.

Further, in a state where the fixing of the hydraulic clamp device 9 is released, the rear mounting plate 6 can move in the left-right direction by the length of the long hole 3c while the piston rod 9c is guided by the long hole 3c of the rear slope part 3. Thus, the rear mounting plate 6 is configured to be movable in the left-right direction between a maximum width position shown in FIG. 2 and a minimum width position shown in FIG. 3 in a state of being integrated with the front mounting plate 5.

Furthermore, a pair of supports 6d are provided on the back surface of the rear end of the rear mounting plate 6. The supports 6d extend downward from a portion slightly behind the rear end of the long hole 6b in a state of being spaced from each other in the left-right direction.

When the rear mounting plate 6 is fixed to the rear slope part 3, the lower ends of the supports 6d are in contact with the upper surface of the base plate 8. Thus, a force acting on the rear mounting plate 6 from above is supported by the supports 6d.

In addition, three supports 6h are provided on the back surface of the front end of the rear mounting plate 6. The three supports 6h extend downward from a portion between the two long holes 6e of the rear mounting plate 6 in a state of being spaced from each other in the left-right direction.

When the rear end of the rear mounting plate 6 is fixed to the rear slope part 3 by the hydraulic clamp device 9, and the front end of the rear mounting plate 6 is fixed to the front mounting plate 5 via the hydraulic clamp device 9A, the lower end of each of the supports 6h is in contact with the upper surface of the base plate 8. Thus, a force acting on the rear mounting plate 6 from above is supported by the supports 6h.

Further, an opening 6g is provided at the center of the rear mounting plate 6. The opening 6g is formed in a rectangular shape in the plan view and penetrates the rear mounting plate 6 in the vertical direction, and is configured to have the same size as the above-described opening 5g of the front mounting plate 5. The exciter 10 is arranged below the opening 6g.

Next, the exciter 10 will be described with reference to FIG. 5 to FIG. 10. FIG. 5 shows a configuration in which the top plate 7 is omitted for easy understanding. In the excitation device 1 of the present embodiment, the exciter 10 arranged below the opening 5g of the front mounting plate 5 and the exciter 10 arranged below the opening 6g of the rear mounting plate 6 have the same configuration. Therefore, the exciter 10 arranged below the opening 5g of the front mounting plate 5 will be described as an example hereinafter.

The exciter 10 is provided on a movable base plate 11 that has a rectangular shape in the plan view, and the movable base plate 11 is fixed to the base plate 8 via a magnet clamp (not shown) in a state where the bottom surface of the movable base plate 11 is in surface contact with the upper surface of the base plate 8.

In addition, four position changing devices 30 and a plurality of free bearings (not shown) are provided on the upper surface of the base plate 8. The four position changing devices 30 are arranged in a rectangular shape in the plan view, and the movable base plate 11 is provided so as to be surrounded by these position changing devices 30.

Each position changing device 30 includes a plurality of toothed pulleys, a toothed belt wound around the pulleys, a motor mechanism driving one toothed pulley, etc. (none is shown). Two ends of the toothed belt of each position changing device 30 are connected to four predetermined portions of the movable base plate 11. Further, a plurality of free bearings are arranged at positions below the movable base plate 11.

With the above configuration, in a state where the fixing of the magnet clamp is released, the movable base plate 11 moves on the base plate 8 while rolling a plurality of free bearings with the rotation of the pulleys in the four position changing devices 30. That is, the movable base plate 11 is configured so that the position of the movable base plate 11 relative to the base plate 8 is changeable. Then, the movable base plate 11 is fixed to the base plate 8 via the magnet clamp at the position thus changed.

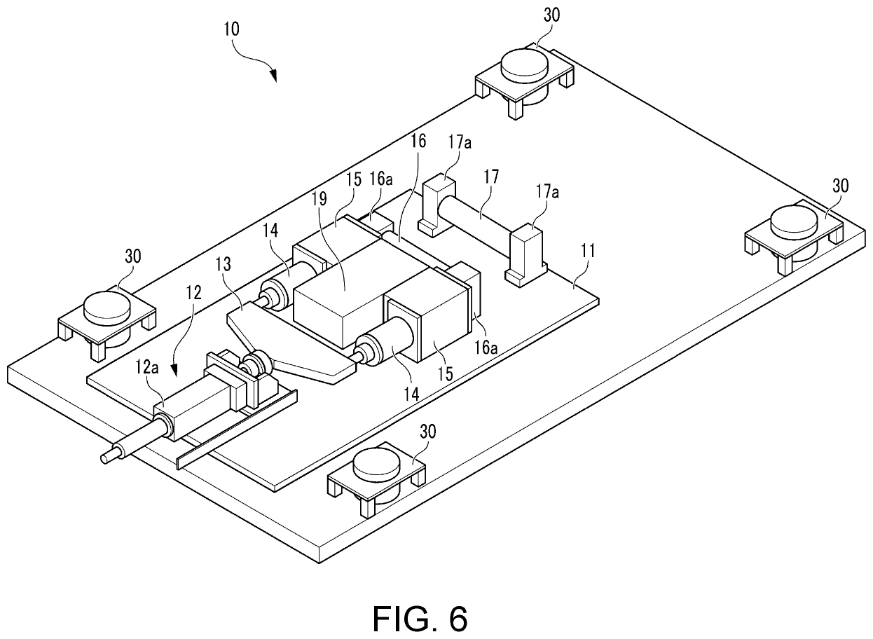

As shown in FIG. 6 to FIG. 10, the exciter 10 includes a hydraulic actuator 12, an excitation arm 13, two excitation shafts 14, two bearing parts 15, the second roller 16, the first roller 17, a ground base 18, a passage base 19, etc.

In FIG. 8 and FIG. 10, hatching of the cross sections of the second roller 16 and the first roller 17 is omitted for easy understanding. Further, in the present embodiment, the second roller 16 corresponds to a component and a second contact part, the first roller 17 corresponds to a component and a first contact part, the ground base 18 corresponds to a component and a grounding part, and the passage base 19 corresponds to a component and a stopper.

The hydraulic actuator 12 includes a hydraulic cylinder 12a, a piston rod 12b, a bracket 12c, etc. The bracket 12c is provided for supporting the hydraulic cylinder 12a, and the lower end of the bracket 12c is bolted to the movable base plate 11. Further, the bracket 12c is bolted to the front mounting plate 5 in a state where the upper end of the bracket 12c is in contact with the lower surface of the front mounting plate 5. The hydraulic cylinder 12a is connected to the hydraulic circuit (not shown), and supplied with the hydraulic pressure from the hydraulic circuit.

The excitation arm 13 is connected to the tip of the piston rod 12b of the hydraulic actuator 12. In the hydraulic actuator 12, the hydraulic pressure supplied from the hydraulic circuit to the hydraulic cylinder 12a is controlled by the control device described above, by which the piston rod 12b is driven. Accordingly, the piston rod 12b is configured to drive the excitation arm 13 in the front-rear direction or to excite.

The left and right ends of the excitation arm 13 are respectively connected to the front ends of the excitation shafts 14 via ball joints 14a. The excitation shafts 14 are arranged at an interval in the left-right direction and extend in the front-rear direction in parallel to each other, and are slidably supported in the front-rear direction by the bearing parts 15.

In each bearing part 15, two hydrostatic bearings 15a are arranged side by side at a predetermined interval in the front-rear direction. The excitation shaft 14 is supported by the hydrostatic bearings 15a so that when the excitation shaft 14 vibrates in the front-rear direction, the vibration in a direction orthogonal to the front-rear direction (for example, left-right front-rear direction) is suppressed.

As shown in FIG. 5, an edge on the front side of the opening 5g of the front mounting plate 5 is an attachment part 5c. The attachment part 5c extends at a predetermined length in the front-rear direction, and the left and right ends of the attachment part 5c are respectively fixed to the upper surfaces of the bearing parts 15 via screws (not shown). Further, the edges 5h of the opening 5g located in the left-right direction of the attachment part 5c of the front mounting plate 5 are also respectively fixed to the upper surfaces of the bearing parts 15 via screws (not shown).

As described above, the upper surfaces of the bearing parts 15 are fixed to the front mounting plate 5 and the lower surfaces of the bearing parts 15 are fixed to the movable base plate 11 so the bearing parts 15 have a function of increasing the rigidity of the mounting table 2.

In addition, bearings 16a are respectively provided at the rear ends of the excitation shafts 14. The second roller 16 extends in the left-right direction at a position at a predetermined height from the upper surface of the movable base plate 11, and two ends of the second roller 16 are respectively supported by the bearings 16a. One-way clutches (not shown) are built in the bearings 16a, by which the second roller 16 is configured to be rotatable around the center axis line only in the clockwise direction (the direction of the arrow Y1) in FIG. 8.

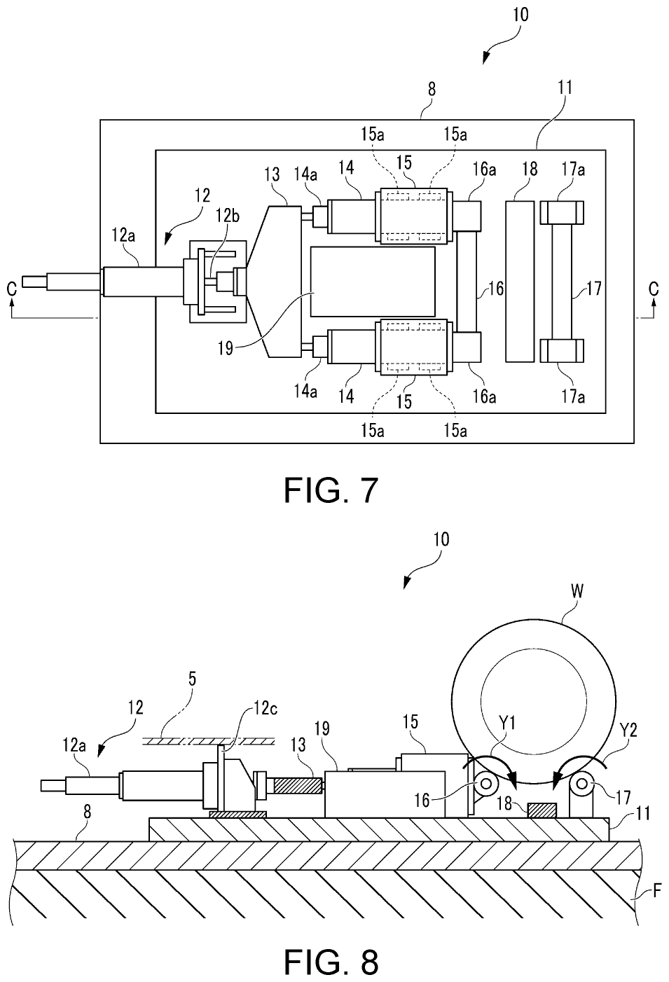

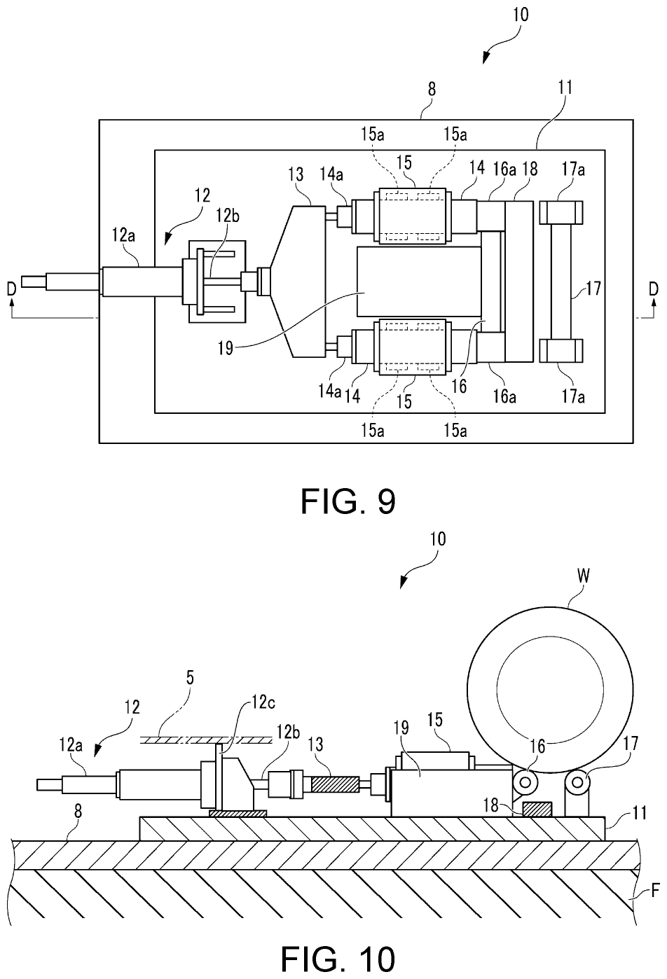

With the above configuration, the second roller 16 is at least driven between an excitation position (for example, the position shown in FIG. 7 and FIG. 8) and a push-out position (for example, the position shown in FIG. 9 and FIG. 10) by the hydraulic actuator 12. In the present embodiment, the excitation position corresponds to a first position and the push-out position corresponds to a second position. Further, the vibration in the front-rear direction generated by the hydraulic actuator 12 is input to the second roller 16 via the excitation arm 13 and the excitation shafts 14.

Behind the second roller 16, the first roller 17 is provided to face and in parallel to the second roller 16. The left and right ends of the first roller 17 are supported by a pair of bearings 17a, and the bearings 17a are fixed onto the movable base plate 11. One-way clutches (not shown) are built in the bearings 17a, by which the first roller 17 is configured to be rotatable around the center axis line only in the counterclockwise direction (the direction of the arrow Y2) in FIG. 8. The first roller 17 is arranged so that the upper end of the first roller 17 is at a position slightly higher than the upper end of the second roller 16. Nevertheless, the first roller 17 may be arranged so that the upper end of the first roller 17 is at the same position as the upper end of the second roller 16.

When the vehicle V is inspected, since the lower side of the wheel W of the vehicle V is held by the first roller 17 and the second roller 16 described above, the size of the first roller 17 and the second roller 16 in the left-right direction is set to a value sufficiently larger than the width of the wheel W.

Further, the above-described ground base 18 is fixed between the first roller 17 and the second roller 16 on the movable base plate 11. The ground base 18 has a rectangular parallelepiped shape that is long in the left-right direction and is arranged in parallel to the first roller 17 and the second roller 16, and two ends of the ground base 18 extend to the same positions as the end surfaces of the pair of bearings 17a.

In the case of the ground base 18, the interval between the upper surface of the ground base 18 and the upper end surface of the rib 5a of the front mounting plate 5 is set to a value smaller than the minimum ground clearance of the vehicle V. This is to prevent the minimum ground clearance portion on the bottom surface of the vehicle V from coming into contact with the upper end surface of the rib 5a of the mounting plate 5 if the interval between the first roller 17 and the second roller 16 is increased for some reason and causes the wheel W to move downward during excitation, etc.

In addition, the above-described passage base 19 is arranged between the bearing parts 15 on the movable base plate 11. The passage base 19 has a rectangular parallelepiped shape that is long in the front-rear direction, and a hydraulic actuator (not shown) is built in the passage base 19. The passage base 19 is driven in the front-rear position at least between a retracted position (for example, the position shown in FIG. 7 and FIG. 8) and a contact position (for example, the position shown in FIG. 9 and FIG. 10) where the passage base 19 contacts the second roller 16 at the push-out position by the hydraulic actuator.

When the passage base 19 moves to the contact position and comes into contact with the second roller 16 at the push-out position, the second roller 16 is held by the passage base 19 to be nonrotatable. This is to hold the second roller 16 in a rotation stopped state so as to transmit the driving force of the wheel W to the second roller 16 and facilitate moving the wheel W forward when the wheel W of the vehicle V moves forward while riding over the second roller 16 after the excitation operation is completed.

Furthermore, the upper surface of the passage base 19 functions as a passage for the wheel W when the wheel W moves forward as described above. Therefore, the height of the upper surface of the passage base 19 is set to the same height as the upper surface of the second roller 16.

The left half of the mounting table 2 is configured as described above, and the right half of the mounting table 2 is configured similarly.

Next, an operation in the excitation device 1 configured as described above when the vehicle V is inspected will be described. First, the hydraulic clamp devices 9 and 9A are loosened so that the two front mounting plates 5 and the two rear mounting plates 6 are set to be movable in the front-rear direction and the left-right direction. Besides, the magnet clamp is loosened so that the four movable base plates 11 are set to be movable relative to the base plate 8.

Then, in the above state, after the four movable base plates 11 are respectively moved to the positions corresponding to the wheelbase and tread of the vehicle V to be inspected by the four position changing devices 30, the four movable base plates 11 are fixed to the base plate 8 by the magnet clamp. With the movement of the movable base plates 11, the two front mounting plates 5 and the two rear mounting plates 6 move to the positions corresponding to the wheelbase and tread simultaneously with the movable base plates 11. Then, at these positions, at the same time as the front mounting plate 5 and the rear mounting plate 6 are fixed to each other via the hydraulic clamp device 9A, the front mounting plate 5 and the rear mounting plate 6 are fixed to the front and rear slope parts 3 via the hydraulic clamp devices 9.

Next, the hydraulic actuator 12 in each exciter 10 is driven, and the interval between the first roller 17 and the second roller 16 is set to a value corresponding to the size of the wheel W of the vehicle V to be inspected. Thereby, the preparation operation for the inspection is completed.

Next, the vehicle V is moved to ride on the mounting table 2 from the rear slope part 3, and as shown in FIG. 11, the four wheels W fit into the openings 5g of the front mounting plates 5 and the openings 6g of the rear mounting plates 6 and move downward, and enter a state of being held by the first rollers 17 and the second rollers 16 from the front-rear direction.

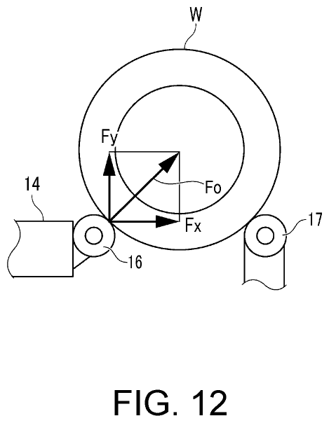

In this state, the hydraulic actuator 12 excites the second roller 16 in the front-rear direction so as to excite the wheel W. During the excitation, when a pressing force Fo of the second roller 16 acts on the wheel W, two force components Fx and Fy of the pressing force Fo act on the wheel W as shown in FIG. 12. That is, by exciting the second roller 16 in the front-rear direction, the wheel W is excited in the front-rear direction and the vertical direction simultaneously.

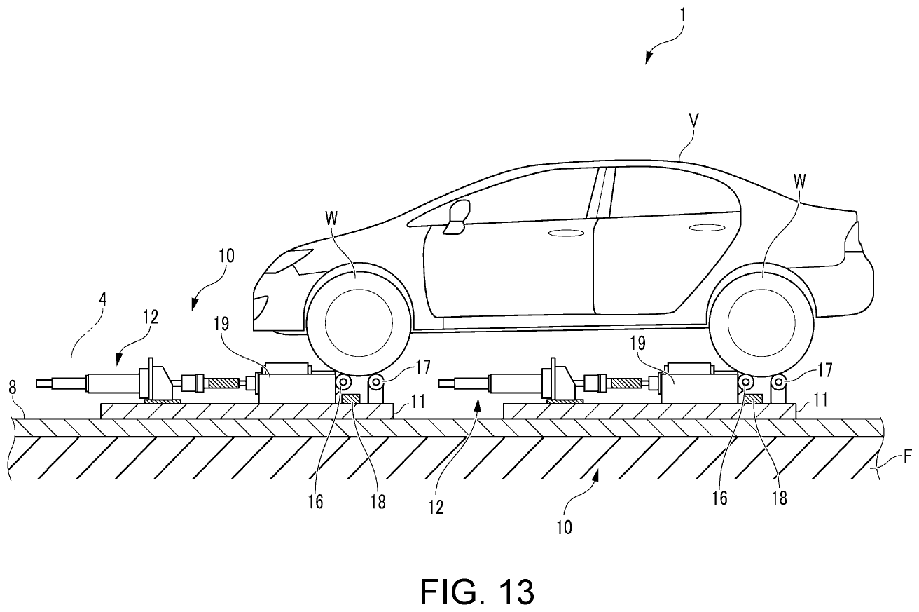

When the excitation operation is performed as described above for a predetermined time and the inspection of the vehicle V is completed, the second roller 16 is moved from the inspection position shown in FIG. 11 to the push-out position shown in FIG. 13 by the hydraulic actuator 12. At the same time, the passage base 19 is moved from the retracted position shown in FIG. 7 and FIG. 8 to the contact position shown in FIG. 9 and FIG. 10 by the hydraulic actuator. Thus, the rear end of the passage base 19 comes into contact with the second roller 16 at the push-out position, so that the second roller 16 is held in the rotation stopped state.

In this state, the vehicle V starts moving forward, by which the wheel W can easily get out of the space between the two rollers 16 and 17 while riding over the second roller 16 in the rotation stopped state. Thus, the vehicle V can move forward and get off the mounting table 2 via the front slope parts 3.

As described above, according to the excitation device 1 of the present embodiment, when the vehicle V is inspected, the lower side of each wheel W is held by the second roller 16 and the first roller 17 from the front-rear direction, and the movement of each wheel W in the front-rear direction is restricted. Then, in this state, the second roller 16 is driven by the hydraulic actuator 12 so that each wheel W is excited in the front-rear direction via the second roller 16. As described above, since all the wheels W are excited from the same direction (front), unlike the excitation device of Patent Document 1, the excitation device 1 of the present embodiment can appropriately reproduce the excited state during traveling of the vehicle.

In addition, since the second roller 16 is driven by the hydraulic actuator 12 in the front-rear direction, the vibration is input to the contact point between the wheel W and the second roller 16 in an oblique direction. Thus, as described above, the force components of the vibration act in the front-rear direction and the vertical direction of the wheel W, and therefore the exciter 10 for exciting the wheel W in the front-rear direction and the vertical direction can be configured with one hydraulic actuator 12. As a result, the manufacturing cost can be reduced as compared with the case of Patent Document 1 which requires two actuators.

Further, the ground base 18 is arranged between the first roller 17 and the second roller 16, and the interval between the upper end of the ground base 18 and the upper ends of the ribs 5a and 6a, which are the highest portions of the front and rear mounting plates 5 and 6, is set to a value smaller than the minimum ground clearance of the vehicle V. Thus, even if the wheel W held between the first roller 17 and the second roller 16 falls downward for some reason during excitation of the exciter 10 and causes the wheel W to touch the ground base 18, a gap remains between the minimum ground clearance of the vehicle V and the upper ends of the ribs 5a and 6a of the front and rear mounting plates 5 and 6, and they can be prevented from contacting each other. Thus, damage to the vehicle V can be avoided, and vehicle maintenance during excitation can be realized.

Furthermore, the second roller 16 is configured to be rotatable only in a rotation direction when the second roller 16 moves away from the wheel W in the state where the second roller 16 is in contact with the wheel W. Thus, at the time of exciting the wheel W, the second roller 16 is in the rotation stopped state when approaching the wheel W so as to transmit the vibration to the wheel W. On the other hand, the second roller 16 rotates in the direction opposite to the wheel W when moving away from the wheel W so as not to transmit the vibration to the wheel W, and thus the wheel W does not receive extra force from the second roller 16.

In this case, during actual traveling, the wheel W receives vibration and force from the traveling direction, but hardly receives vibration and force from the direction opposite to the traveling direction. Accordingly, with the simple structure of the two rollers 16 and 17, vibration can be input to the wheel W from one direction as in actual traveling, and the excited state during traveling of the vehicle can be appropriately reproduced.

In addition, as described above, the second roller 16 is driven by the hydraulic actuator 12 in the front-rear direction within a predetermined range between the excitation position and the push-out position, and when the second roller 16 is at the push-out position, the rear end of the passage base 19 comes into contact with the second roller 16 so that the second roller 16 is held in the rotation stopped state. Thus, when the vehicle V moves after the excitation is completed, the wheel W can easily get out of the space between the two rollers 16 and 17 while riding over the second roller 16 in the rotation stopped state, which is more convenient.

The embodiment illustrates an example of using the first roller 17 as the first contact part. However, the first contact part of the disclosure is not limited thereto and may be any part arranged to contact each wheel from one direction in the front-rear direction of the vehicle so as to restrict the movement of each wheel to the one direction in the front-rear direction of the vehicle. For example, a round bar, a square bar, an inclined plate, etc. may be used as the first contact part.

Further, the embodiment illustrates an example of using the second roller 16 as the second contact part. However, the second contact part of the disclosure is not limited thereto and may be any part arranged to be movable in the front-rear direction of the vehicle and to contact each wheel from the other direction in the front-rear direction of the vehicle so as to hold the lower side of each wheel between the first contact part and the second contact part. For example, a round bar, a square bar, an inclined plate, etc. may be used as the second contact part.

Furthermore, the embodiment illustrates an example of using the hydraulic actuator 12 as the actuator. However, the actuator of the disclosure is not limited thereto and may be any device that drives the second contact part in the front-rear direction of the vehicle so as to excite each wheel via the second contact part. For example, an electric actuator may be used as the actuator.

The embodiment illustrates an example of using the ground base 18 as the grounding part. However, the grounding part of the disclosure is not limited thereto and may be any part arranged between the first contact part and the second contact part so as to ground each wheel. For example, a round bar having a circular cross section or a bar having a polygonal cross section may be used as the grounding part.

Further, the embodiment illustrates an example of using the front and rear mounting plates 5 and 6 as the guiding parts. However, the guiding part of the disclosure is not limited thereto and may be any part arranged above a plurality of components and having an opening that has a size larger than the size of the tread of each wheel in the front-rear direction and the left-right direction so as to guide each wheel between the first contact part and the second contact part. For example, a single plate-shaped member may be used as the guiding part.

Furthermore, the embodiment illustrates an example of using the front and rear mounting plates 5 and 6 as the highest components. However, the highest component of the disclosure is not limited thereto and may be the highest component among a plurality of components other than the grounding part. For example, the first roller 17 or the second roller 16 may be configured so that the upper end thereof is higher than the upper ends of the ribs 5a and 6a of the front and rear mounting plates 5 and 6 so as to serve as the highest component.

In addition, the embodiment illustrates an example of using the passage base 19 as the stopper. However, the stopper of the disclosure is not limited thereto and may be any part that comes into contact with the second roller when the second roller is at the second position so as to stop the rotation of the second roller. For example, a linear actuator may be used as the stopper, and the tip thereof may be configured to contact the second roller at the second position.

What is claimed is:

1. An excitation device, comprising:
a plurality of components respectively exciting a plurality of wheels of a vehicle to be excited, and located below a minimum ground clearance portion of the vehicle during excitation,
wherein the plurality of components comprise:
a first contact part arranged to come into contact with each of the wheels from one direction in a front-rear direction of the vehicle and restrict movement of each of the wheels to the one direction in the front-rear direction of the vehicle;
a second contact part arranged to be movable in the front-rear direction of the vehicle and to come into contact with each of the wheels from an other direction in the front-rear direction of the vehicle and hold a lower side of each of the wheels between the first contact part and the second contact part;
an actuator driving the second contact part in the front-rear direction of the vehicle and exciting each of the wheels via the second contact part; and
a grounding part arranged between the first contact part and the second contact part and grounding each of the wheels,
wherein an interval between an upper end of the grounding part and an upper end of a highest component among the plurality of components other than the grounding part is set to a value smaller than a minimum ground clearance of the vehicle.

2. The excitation device according to claim 1, wherein the plurality of components further comprise a guiding part as the highest component, wherein the guiding part has an opening having a size larger than a size of a tread of each of the wheels in the front-rear direction and a left-right direction and guides each of the wheels between the first contact part and the second contact part, and
the first contact part and the second contact part are arranged below the opening of the guiding part.

3. The excitation device according to claim 1, wherein the first contact part and the second contact part respectively comprise a first roller and a second roller that are rotatable around an axis line extending in a vehicle width direction of the vehicle, and
the second roller is configured to be rotatable only in a rotation direction when the second roller moves away from each of the wheels in a state where the second roller is in contact with each of the wheels.

4. The excitation device according to claim 2, wherein the first contact part and the second contact part respectively comprise a first roller and a second roller that are rotatable around an axis line extending in a vehicle width direction of the vehicle, and
the second roller is configured to be rotatable only in a rotation direction when the second roller moves away from each of the wheels in a state where the second roller is in contact with each of the wheels.

5. The excitation device according to claim 3, wherein the second roller is driven by the actuator at least between a first position where each of the wheels is held between the first roller and the second roller, and a second position closer to a first roller side than the first position, and
the plurality of components further comprise a stopper that comes into contact with the second roller when the second roller is at the second position, and stops rotation of the second roller.

6. The excitation device according to claim 4, wherein the second roller is driven by the actuator at least between a first position where each of the wheels is held between the first roller and the second roller, and a second position closer to a first roller side than the first position, and
the plurality of components further comprise a stopper that comes into contact with the second roller when the second roller is at the second position, and stops rotation of the second roller.
